(19) United States
(12) Patent Application Publication
(10) Pub. No.: US 2006/0065358 A1
(43) Pub. Date: Mar. 30, 2006

(54) Method and apparatus for substantially simultaneously cleaning internal and external regions of plastic frames

(76) Inventor: John P. Cupp, Philadelphia, PA (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/169,489

(22) Filed: Jun. 29, 2005

Related U.S. Application Data
(63) Continuation-in-part of application No. 10/254,901, filed on Sep. 25, 2002, now Pat. No. 6,918,986.

(51) Int. Cl. B29C 65/00

(52) U.S. Cl. 156/267; 156/502; 156/510; 156/304.5; 156/304.6

(57) ABSTRACT

Method and apparatus for internal and external trimming plastic frames and the like. Two plastic members are joined to bring heated, soften ends into engagement, causing some softened material to be forced out from between the engaged portions, forming internal and external flashing, which is trimmed in a first region by a pair of trimming blades moving along associated guides. The guides are mounted upon clamps holding the frame members, enabling performance of the trimming operation in the first region and eliminating the need for moving to a separate trimming/finishing station remote from the joining equipment. Excellent cutting action is assured by locking the guide blocks. Various combinations and sequences of repetitive trimming operations may be selected the blades being selectively moved providing a trimming operation which avoids the need for further finishing. Trimming may be performed simultaneously on multiple stacks of members being joined. Interior trimming is performed by moving an interior trimming member into trimming position along a path which avoids interference with the heating, joining and external trimming members. The interior member has a tool head that can be filled with a variety of different tools.

This application is a continuation-in-part of pending application Ser. No. 10/241,901 filed Sep. 25, 2002.

### FIELD OF THE INVENTION

The present invention relates to method and apparatus for trimming and/or cleaning flashing on plastic frames, for example, which forms when plastic members are fused together. More particularly, the present invention relates to method and apparatus for substantially simultaneously joining and trimming flashing and cleaning internal and external surfaces of plastic frames without the need for removing the joined members from the joining equipment and transporting the members to a remote cleaning/trimming/polishing station.

### BACKGROUND

High speed automatic equipment for joining frame components which have been cut to size and supplied to such equipment for fabricating a frame or a frame-like structure, are well known in the art.

The typical operation is to provide plastic frame members which have been processed preparatory to the joining operation to form a frame, for example. Although machines of this nature are capable of simultaneously joining substantially all four corners of a frame structure, a description will be given herein of the manner in which two frame members forming one corner of the frame structure are joined, it being understood that the remaining three corners are formed in a substantially identical manner and are also performed substantially simultaneously with the corner joining operation described hereunder.

The frame members, which have previously been precision mitred to form a corner, are placed in the machine, typically referred to as a conventional 4-point welder structure, are positioned within clamping devices and are moved towards one another so that the surfaces to be joined engage a locator plate which typically provides a gap of the order of one quarter inch (0.25″) between the surfaces to be joined. The clamping devices clamp the frame members in place so that the surfaces to be joined extend a given distance beyond their clamping devices in a direction toward the opposite clamping device.

The clamping devices are then moved apart by an amount sufficient to enable the locator plate to be withdrawn. After the locator plate is withdrawn, a heated plate is placed in the gap region between the surfaces to be joined. The clamping devices then move the frame members towards one another causing the surfaces to be joined to engage opposing surfaces of the heated plate which heats the surfaces to be joined to a level sufficient to heat a marginal end portion of each frame member to a softened or molten state. This is accomplished by adjusting/controlling the temperature of the heated plate and the time interval during which the engaging surfaces of the frame member are in contact with the heated plate to achieve the desired softened/molten state.

Thereafter, the clamping assemblies are moved to separate the frame members to enable the heated plate to be withdrawn. After the heated plate has been removed from the region between the heated, softened surfaces, the clamping members are moved to bring the softened molten, surfaces of the cooperating frame members into intimate engagement. This action causes the heated surfaces to fuse together as they undergo cooling. In addition, the bringing together of the frame members causes some of the softened material to be squeezed out from the region between the joined ends of the engaged frame members, whereby the softened material squeezed out from between the joined surfaces, forms an undesirable flashing. The flashing may extend outwardly from the external surfaces and inwardly from the interior surfaces.

After the frame members have cooled sufficiently, the frame is removed from the clamping assemblies.

The frame assembly is removed to a separate location from the four-point welding equipment to undergo trimming and polishing, necessitating: removal of the completed frame; transportation to a trimming/polishing station; clamping of the frame at the trimming/polishing station; and performing the trimming/polishing operations. In addition, the techniques presently used for trimming/polishing the flashing typically require a large amount of manual labor to obtain frames having the desired clean, aesthetic appearance, especially in the regions of the joined corners.

### SUMMARY

The present invention is characterized by comprising method and apparatus for performing both an exterior and an interior trimming and/or cleaning operation which takes place at the welding station and during the welding cycles, thereby significantly reducing both the time and the amount of handling required in the employment of conventional techniques while totally eliminating the need to transport frame assemblies requiring trimming and/or cleaning operations to a second location for performance thereof. In addition the present invention is characterized by comprising method and apparatus for performing trimming operations which provide a frame having a clean, aesthetically pleasing appearance in the external regions of the mitred corners as well as cleaning the interior region of the welded seams while eliminating the need for the labor intensive activities which are necessary when employing conventional techniques.

The present invention is characterized by comprising method and apparatus for mounting the trimming assembly directly upon an automated welder system, which may be a single point, two (2) point or four (4) point welder for joining frame members whose center lines are perpendicular as well as joining members whose longitudinal center lines are parallel or form any angle therebetween, enabling the trimming operation, as well as other operations, to be performed while the joined members of the frame are still mounted in the automated welder, thereby totally eliminating the need for removal of the frame from the automated welder and transporting and mounting the frame upon separate trimming/polishing equipment.

More specifically, the apparatus of the present invention comprises guide blocks joined to the clamping assemblies of the welder equipment. The trimming apparatus comprises a pair of guide members which serve to guide reciprocally mounted trimming blade assemblies. Actuators are provided for each of the trimming blade assembles for selective extension and retraction thereof. In addition thereto, a latching assembly is provided for selectively latching the guide blocks to one another to prevent their movement during the operation of the trimming blade(s), thereby assuring clean, effective trimming of the flashing which avoids the need for additional finishing/polishing after removal of the frame from the welding apparatus. Latching activators are provided separately and independently of the trimming blade assembly activators for selectively latching and delatching the guide blocks.

The activators may be electrically operated solenoids, motor driver ball gears or hydraulic or pneumatic devices. In one preferred embodiment, the activators are pneumatically controlled activators forming a part of a pneumatic system for operating the latches at a first pressure level known as “shop psi” for operating the latches and moving the trimming blades in the retraction direction and being provided with a booster regulator for extending the trimming blades at a higher pressure level hereinafter referred to as a “high psi.”

The external and internal trimmings are preferably operated under control of a programmed logic controller (PLC) for automatically controlling the trimming system through a preprogrammed sequence and further automatically initiating operation responsive to control signals from the automated welder system, enabling operation of the trimming system in proper synchronizing and time relationship with the automated, welder equipment.

The guide blocks and cutting blades may be designed to accommodate a variety of different frame structures so as to provide trimming for frames of complex cross-section configurations as well as cross-sections of simple shapes having substantially flat external surfaces at the same time without interfering with or complicating the design and operation of the welder equipment, enabling operation of the welder equipment without any design modifications to accommodate the trimming system.

The cooperating cutting blades may be operated to perform a variety of different combinations of cutting/shearing steps to perform a trimming operation which removes flashing from the joined ends of frames and the like to a degree sufficient to eliminate the need for any further trimming/polishing operations.

The interior cleaning unit is used to clean welded flash materials from the inside corners of welded plastic members. Cleaning is accomplished on the welding machine and is performed during the welding process time, eliminating the need for any further cleaning/processing steps following the welding of the materials.

The inside cleaning unit, in it's simplest form, requires no more than basic logic motion, but may be moved to define a curved path as well as two sequentially performed linear paths. The interior cleaning system may also be controlled utilizing single or multiple-axis controls for programmable positioning, allowing many different shapes and sizes of material processing on the same system without the need for manually changing the cleaning tool. The control may be programmed in a learning phase to accommodate joined frames of different sizes and shapes.

The interior cleaning unit can also be utilized to perform multiple processes such as drilling, milling, grinding, polishing, routing, punching, and the like, merely by mounting the appropriate tool. The interior cleaning system can be used independently or in conjunction with an external cleaning system used for external (i.e., outside corner, top and bottom) profile cleaning.

### BRIEF DESCRIPTION OF THE DRAWINGS

The invention will be described in detail hereinbelow making reference to the drawings, in which:

FIG. 1 is a simplified diagram showing the actuators for the trimming and locking operations and the programmed logic controller for operating the actuators in accordance with a pre-programmed sequence.

FIG. 2 is a plan view showing the fixtures for holding frame members to be joined and the pressure lines comprised thereof.

FIGS. 3a and 3b are perspective views showing the fixtures of FIG. 2 in greater detail.

FIG. 4 is a perspective view of the fixtures of FIGS. 2, 3a and 3b with portions thereof removed to facilitate an understanding of the operations of the various actuators employed in the trimming system.

FIG. 5 is a top plan view showing the locking system in greater detail.

FIGS. 6a and 6b respectively show a top plan view and an end view of a boot holding four (4) trimming blades.

FIGS. 7a, 7b and 7c are front, side and top views of blade “1” in FIG. 6b.

FIGS. 8a, 8b and 8c are front, side and top views of blade “2” in FIG. 6b.

FIGS. 9a, 9b and 9c are front, side and top views of blade “3” in FIG. 6b.

FIGS. 10a, 10b and 10c are front, side and top views of blade “4” in FIG. 6b.

FIGS. 11a and 11b are tables showing two possible programmed sequences of the trimming operations obtainable through the programmed logic controller of FIG. 1.

FIGS. 12a-12d are cross sections of the different profiles of frame members capable of being joined and trimmed employing the system of the present invention.

FIGS. 13a-13c are cross sections of other profiles of frame members capable of being trimmed by the system of the present invention, and respectively showing trimming apparatus adapted for use in trimming a single stack, a double stack and a four-high stack of profiles.

FIGS. 14a-14k are perspective views showing various stages in the interior cleaning system.

### DETAILED DESCRIPTION OF THE PREFERRED EMBODIMENTS

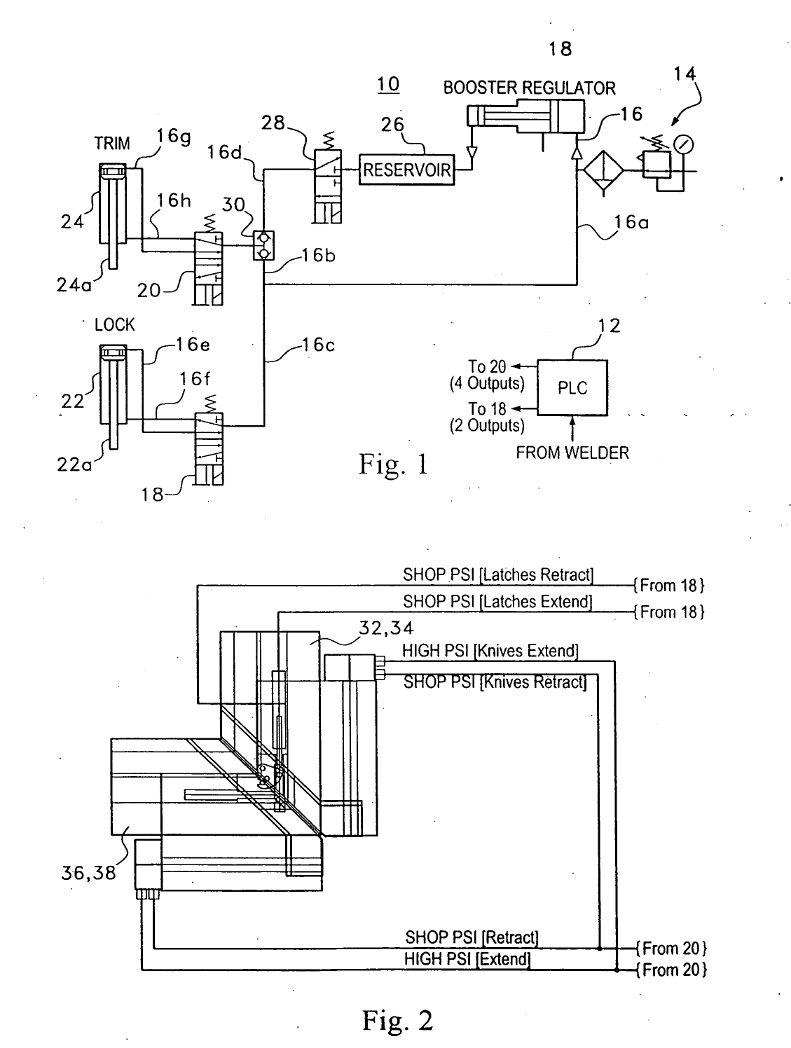

FIG. 1 is a simplified block diagram showing an actuator system 10 for selectively operating the reciprocating trimming knives and the locking mechanism. A programmable logic controller (PLC) 12 is programmed to operate the trimming and locking actuators in a predetermined sequence which can be modified according to the type of profile being trimmed.

A source 14 provides the desired “shop” pressure, typically of the order of 90 psi, which is coupled through line 16 to a booster regulator 18, and line 16a to 16b and 16c which are respectively coupled to solenoid-operated control valves 18 and 20 for respectively operating the fixture locking cylinder 22 and trimming blade cylinder 24.

The output of booster 18, which is of the order of 170 psi, is coupled to a safety valve 28 through reservoir 26. A pair of one-way valves provided in valve structure 30 prevent the pressure in high pressure line 16d from entering into low pressure line 16b, and vice versa.

The PLC 12 receives a signal from the 4-point welder, as will be more fully described, to initiate the operation of the trimming apparatus.

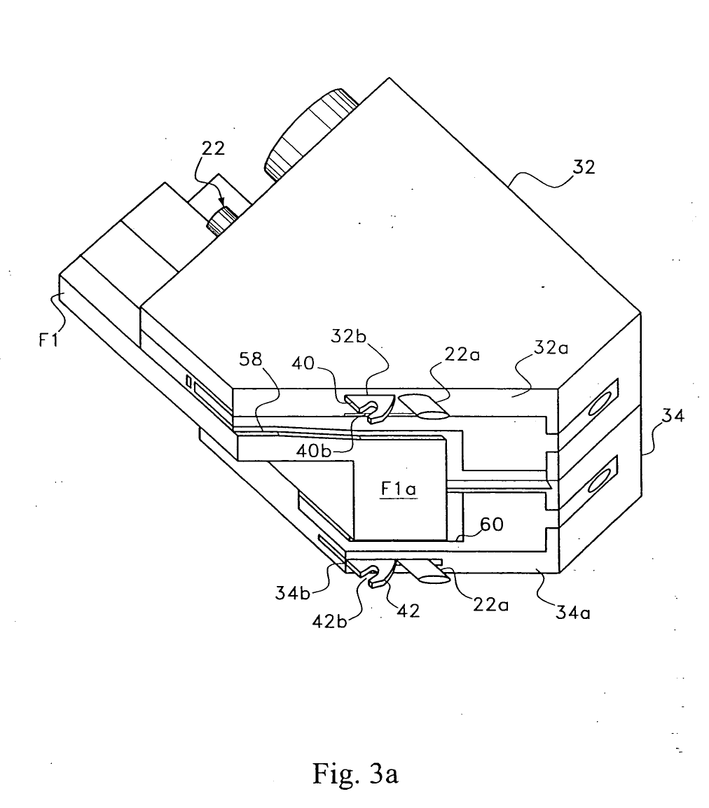

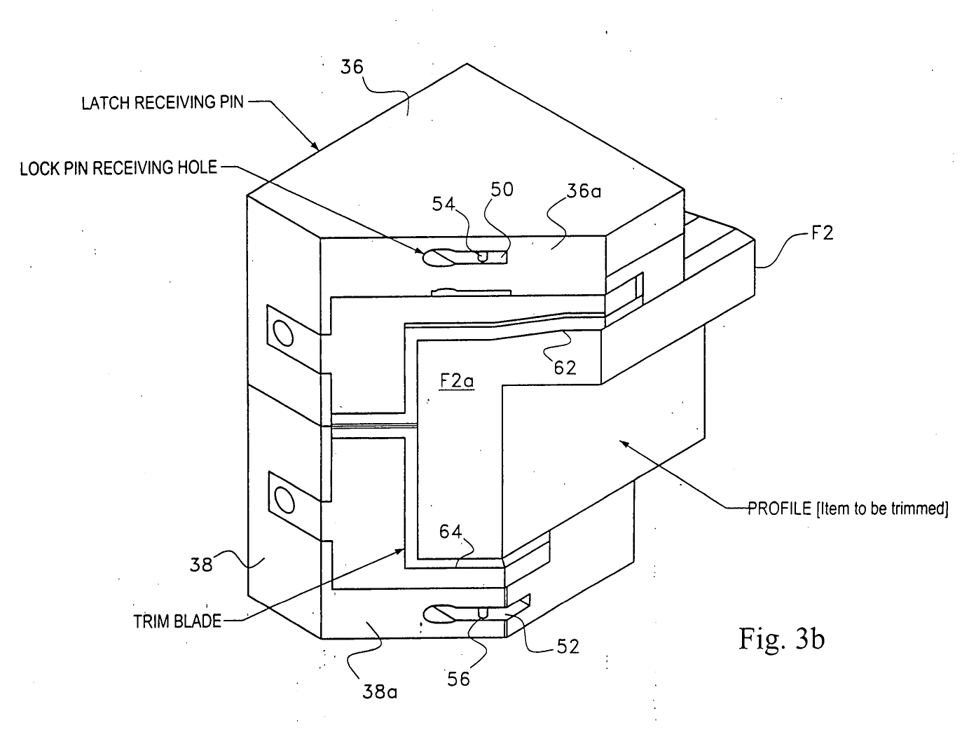

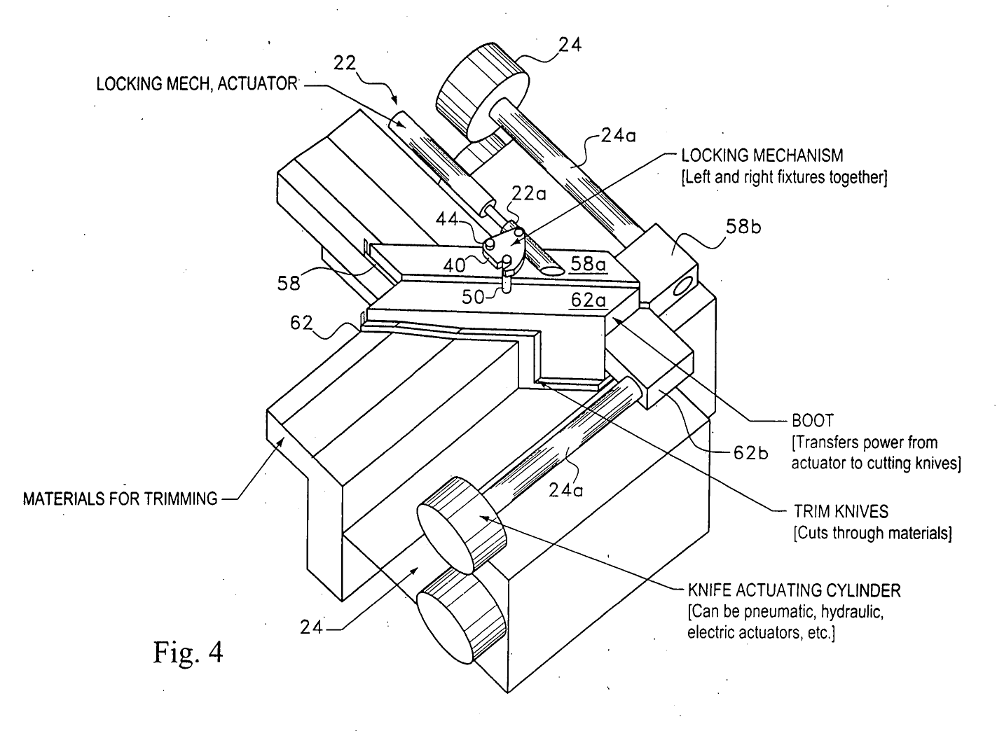

The cooperating fixtures are shown in FIGS. 3a and 3b separated from one another while FIG. 4 shows the fixtures in the trimming-ready position locked together in readiness for operation of the trimming blades. The upper and lower fixtures 32 and 34 embrace one of the frame members F1 therebetween and are each provided with diagonally aligned faces 32a and 32b which are arranged to be directly opposite the diagonally aligned faces 36a and 38a of the upper and lower fixture members 36 and 38, respectively, which receive a cooperating frame member F2. The fixtures 32-34 and 36-38 are arranged in the manner shown in FIGS. 2 and 4 and clamp the frame members F1 and F2 in the manner shown so that their cooperating surfaces to be joined are arranged in space parallel fashion and are maintained in this alignment throughout the welding and trimming operation. The end surfaces of frame members F1 and F2 protrude of the order of 0.25 inches beyond the end surfaces of their associated fixtures. Each upper and lower fixture 32 and 34 is provided with an elongated slot 32b, 34b for slideably receiving and guiding a locking actuator 22 as shown in FIG. 1, as well as a swingably mounted locking plate 40 and 42.

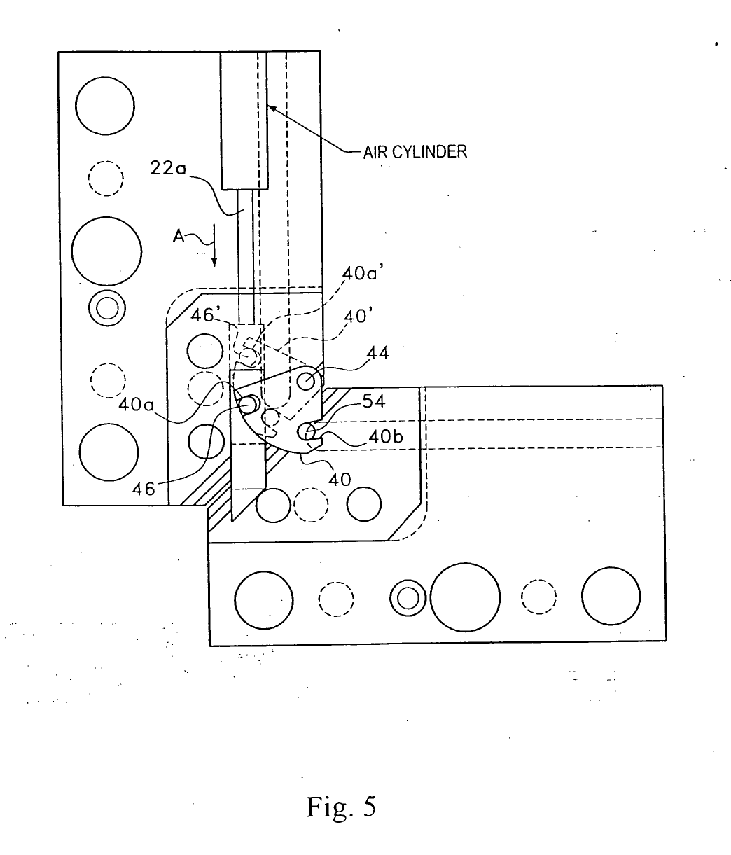

Each locking plate is mounted to pivot about a pivot pin 44, only one of which is shown in FIG. 4 and in FIG. 5, and is swingable between a retracted position 40 shown in dotted fashion and a locking position 40′ shown in solid line fashion in FIG. 5. Other locking techniques may be used to restrain the fixture from moving during operation of the trimming blades. For example, as shown in FIG. 5a, the plate 45 which functions in a manner similar to the plate 40 of FIG. 5, enters into a slot 50′ in upper fixture 36′ and containing pin 54. Plate 40′ has an open slideably receiving pin 44′ in the slot of fixture 32′. As the two fixtures 32′ and 36′ move together, the locking plate 40′ moves over pin 54. Cylinder 22′ operates by extending piston rod 22a ‘causing the end portion 22b’ to engage the tapered end 45a of an operating lever 45 causing its opposite end to press locking plate 40′ downwardly causing pin 54 whose upper end 54′ is tapered, to enter opening 40b′ and thereby lock fixtures 32′ and 36′ against movement during the trimming operation.

Locking plate 40 of FIGS. 4 and 5, for example, is swung about pivot 44 by means of a pin 46 on piston arm 22a which is received within a slot 40a provided in locking plate 40. The fixture locking actuator cylinder 22 shown in FIGS. 1, 3a, 4 and 5, drives piston arm 22a in the direction of arrow A to move locking plate 40, by pin 46, in a counter clockwise direction about pivot pin 44, as shown in FIG. 5, so as to reach the locking position. As was mentioned hereinabove, the shop pressure (typically 90 psi) enters into cylinder 22 through line 16e under control of the solenoid operated valve 18 when in a first state. Piston 22a is retracted by operating solenoid controlled valve to move to a second state to apply shop pressure to cylinder 22 through line 16f causing the blocking plate 40 to occupy the dotted line position 40′ shown in FIG. 5.

The upper and lower fixtures 36 and 38 shown in FIG. 3b are each provided with elongated slots 50 and 52 which slidably receive the free ends of the pistons 22a and also receive at least a portion of the locking plate 40. Each of the slots 50 and 52 is provided with a locking pin 54, 56 which cooperates with locking slot 40b in each locking plate 40. FIG. 4 shows a portion of the upper fixture 32 removed to expose the locking mechanism actuator cylinder 22 and showing the piston 22a in the extended state, causing the locking plate 40 to be pivoted into the position where its slot 40b captures the pin 50 shown in FIG. 3b, the locking position being shown best in FIGS. 4 and 5.

It should be understood that the upper fixtures 32 and 36 are locked to one another and that the lower fixtures 34 and 38 are locked to one another, the lower locking fixture assembly being substantially identical in design and function to the upper locking fixture description described hereinabove. The locking mechanism prevents the fixtures from moving relative to one another when the trimming blades are operated to prevent the frames being joined from experiencing any movement during trimming of the flashing and also to prevent the cooperating fixture members from moving during the trimming operation, thereby providing a trimming operation which completely removes the flashing, thus avoiding the need for any further trimming and/or polishing operations.

The locking mechanism actuating cylinders 22 are operated to retract the pistons 22a upon completion of the trimming operation to enable separation of the fixtures preparatory to removal of the joined frame members.

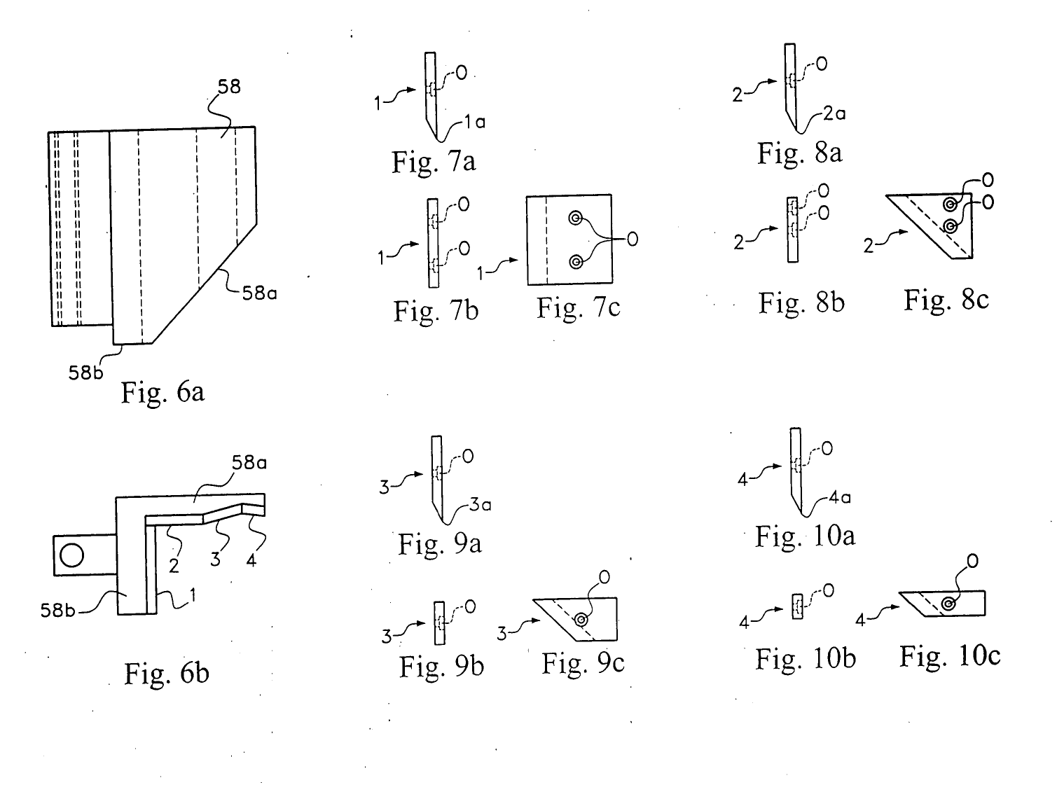

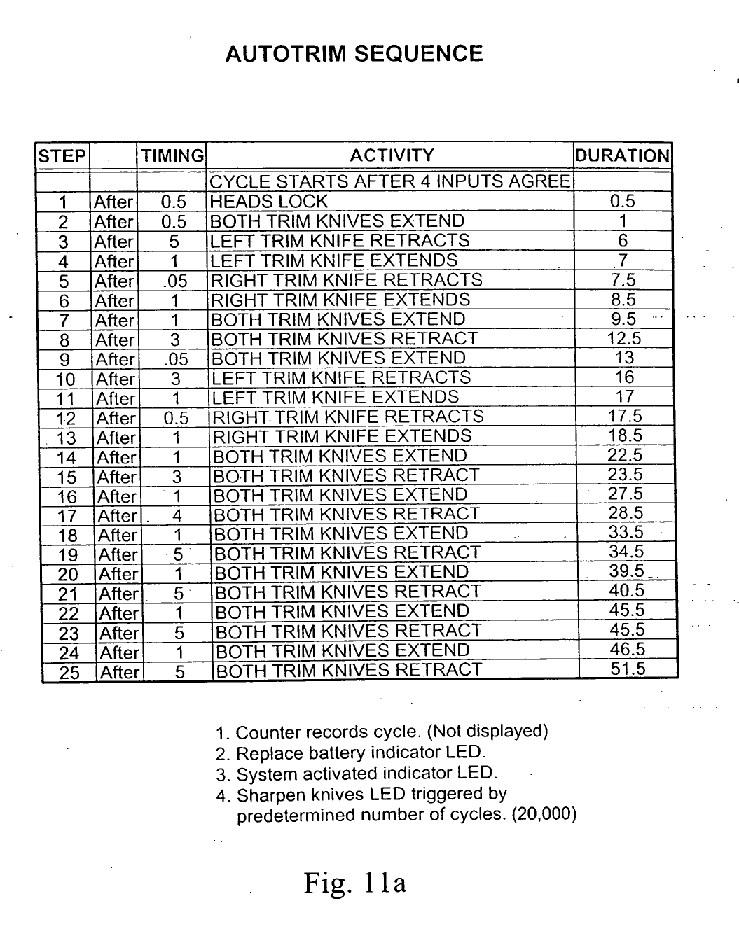

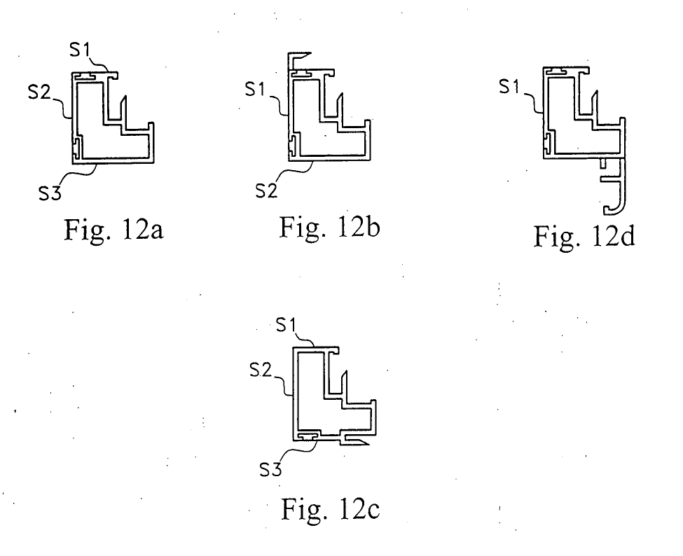

Each of the fixtures 32, 34, 36 and 38 is provided with a reciprocating trimming blade assembly 58, 60 shown in FIG. 3a and 62, 64, shown in FIG. 3b. The blade assembly has its blades joined to a boot B, each boot having a projection which is driven by an associated trimming cylinder 24. FIGS. 6a and 6b are top and front end views of a boot holding four (4) trimming blades 1, 2, 3, and 4, which are secured to the boot B by suitable fastening screws (not shown). FIGS. 7a-10c show front, side and top views of blades 1-4. Openings O in the blades 1-4 receive the aforementioned fasteners for securement to boot B. The cutting edges 1a-4a are arranged along the edges of the boot B. A plurality of blades are employed to trim flashing in the embodiment of FIGS. 6a, 6b. Blades may be provided to trim flashing from outside corners. Surfaces S1, S2, etc. of the more complex frames of FIGS. 12a to 12c are the surfaces trimmed by the trimming blades. It should be understood that the number, sizes and configurations of the blades are a function of the surfaces of the frames to be trimmed and may be easily designed/modified to accommodate different profiles whether simple or complex.

FIG. 2 shows a simplified plan view of one corner trimming assembly showing the pneumatic lines coupled thereto for activating the latching and trimming assemblies.

FIG. 3a is a perspective view showing a portion of the trimming assembly of FIG. 2 which incorporates the latching hook and the pneumatic activators therefor.

FIG. 3b is a perspective view showing the latching assembly portion which cooperates with that shown in FIG. 3a and having the latch receiving slot for receiving the latching hook which is latched to the pin provided in the slot.

FIG. 4 shows portions of the upper fixtures 32 and 36 removed, exposing the trimming actuator cylinders 24 the boots 58a, 62a and the boot projections 56b and 62b. Each of the trimming actuator cylinders 24 is provided with a piston 24a, each piston having its free end coupled to the associated boot projection 58b, 62b. Making reference to FIGS. 1 and 2, solenoid operated valve 20, in a first position, couples the high pressure line 60d to line 16g causing the piston 24a to be extended, driving the associated trimming blade toward the trimming/cutting position. When the solenoid operated valve 20 is moved to a second state, compressed air at shop psi (typically 90 psi) is coupled to cylinder 24 through line 16h retracting the associated trimming blade at the lower pressure level.

Although FIG. 1 shows only a single trimming actuator cylinder 24 and locking actuator cylinder 22, it should be understood that two locking activating cylinders 22 are provided at each corner assembly comprised of upper and lower fixtures as shown in FIGS. 3a and 3b and that four trimming actuating cylinders are provided at each corner for selective operation of the trimming knives 58, 60, 62 and 64.

A typical operating sequence will now be described.

Initially, the welding operation takes place prior to the trimming operation. It should be understood that the welding operation may comprise equipment for fusing all four corners of a frame or alternatively for fusing only one corner, it being understood that the present invention may be utilized with equal success and efficiency in either single corner or four corner fusing equipment as well as 2 or 3 corner (i.e., 2 or 3 point) welding units.

The operation of the joining of two frame members at one corner will be described herein for purposes of simplicity, it being understood that the welding and trimming operations that are not shown are substantially identical in design and function.

The frame members F1 and F2 to be joined are respectively placed between the fixture pairs 32-34 and 36-38. Although not shown for purposes of simplicity, it should be understood that suitable clamping means that such as hydraulically or pneumatically operated clamping pistons or electrically operated solenoids urge the cooperating fixtures 32-34 and 36-38 toward one another to suitably clamp the frame member F1 and F2 therebetween.

A locator plate, not shown for purposes of simplicity, is extended into the region between the fixture pairs 32-34 and 36-38 and the fixtures are closed into the locator plate. The members being joined are inserted into the fixtures and the clamping actuators clamp the frame members in place. As is conventional, the processed ends F1a and F2a of the frame members of F1 and F2 are arranged by the locator plate so as to extend slightly beyond the end faces of the fixtures. For example, the mitred end of frame member F1 is arranged to extended preferably about ⅛^{th} of an inch beyond faces 32a and 34a for fixtures 32 and 34. Frame member F2 has its processed surface F2a extending a similar distance beyond the faces 36a and 38a of fixtures 36 and 38. These distances may be modified according to the materials being joined, as well as other factors.

With the frame members in this position and locked in place, the fixtures are moved apart and the locator plate is retracted. The heating plate is then extended into the gap between the mitred end surfaces and the fixtures are moved towards one another causing the end surfaces to make contact with the heated plate in order to melt the end portion of each frame member for a period sufficient to render the plastic material softened or molten. The ends of the frame members F1 and F2 are typically maintained in contact with the heat plate for approximately 20 seconds. The heat plate is typically maintained at a temperature of 450° F. when joining frames formed of PVC, for example, which is used for storm windows and the like. Other materials may require different temperatures and different dwell times according to the material being used. For example, resilient gaskets used in refrigerators for sealing a refrigerator door, require less heat to soften the material sufficient for fusing two joined pieces.

Thereafter, the fixtures are moved apart and the heat plate is retracted from the region between the fixtures. The fixtures are then moved into an engaged position joining the heated, softened, molten ends of the frame members. The members are maintained in this fusion position for about 20 to 25 seconds, allowing the frame members to be fused together and cooled.

In the present invention, the PLC 12 takes the signal from the welder assembly which may be signals provided to 24 volt dc solenoids employed in conventional welder machines.

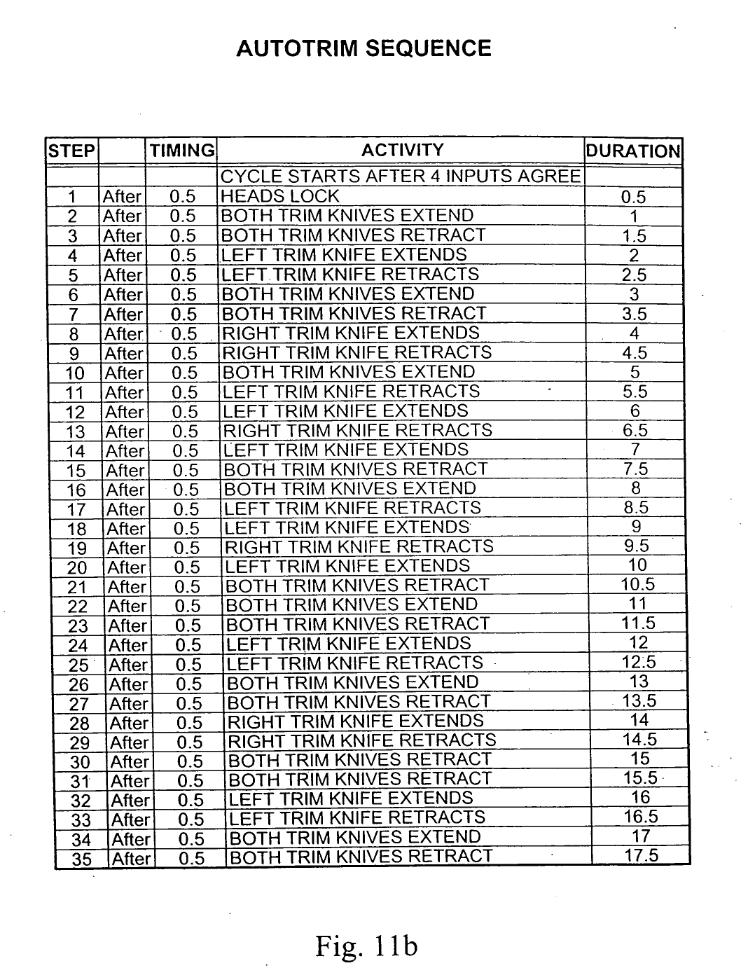

The trim cycle begins whereby PLC 12, upon receipt of the appropriate signal from the welder, operates the solenoid controlled valves 18 causing the valves to couple the “shop” psi to the line 16e of the locking mechanism actuator cylinder 22 whereupon the piston arms 22a are extended causing the latching plates 40 and 42 to enter into the cooperating slots 50 and 52 in fixtures 36 and 38 (see FIGS. 3a and 3b) whereby the slot 40b in the upper latching plate 40 and 42b in the lower latching plate 42 move into the locking position with the associated locking pins 54 and 56, the manner in which the cooperating locking pin 54 is received within slot 40b of locking plate 40 being shown best in FIG. 5. Once the locking plates are in the locking position, the trimming operation can now be initiated. FIG. 11a shows a table of one trimming sequence comprised of 25 steps. The headings of the five columns reading from left to right are the step numbers; relationship to each step of the prior step (i.e. is it before or after); the timing of each step; the activity of each step and the total time elapsed.

Making reference to the table shown in FIG. 11a, initially the heads lock and thereafter actuating cylinders 24 are activated whereby the higher psi is applied to the lines 16g causing both pairs of trimming blades, i.e. the upper pair of assemblies 58-62 and, simultaneously therewith the cooperating lower pair of trimming knife assemblies 60-64 provided in the lower fixtures 34-38, to be extended.

At step 3 the left trimming knife of each trimming pair, i.e., the trimming knives of assemblies 58 and 60 of fixtures 32 and 34, are retracted. At step 4 the left trimming knives of assemblies 58 and 60 are then extended. At step 5, the right trimming knives i.e. the trimming knives of assemblies 62 and 64 of the upper and lower fixtures 36 and 38 are retracted at the lower psi and then at step 6 they are extended at the higher psi. By retracting and extending the trimming blade assemblies 58-64 through a number of different steps, this assures the complete removal of the flashing. The number of steps typically may vary in accordance with the nature of the members and/or materials being fused. For example, when making gasket frames formed of a resilient compressible material, it has been found that such materials require a lesser number of steps to perform a trimming operation. Thus, according to the material, the program is selected which removes the flashing without the need for further removal by cutting by hand and/or polishing.

In addition to operating the trimming blades so as to open and close simultaneously or so as to hold one blade closed while the other is repeatedly opened and closed, a shearing operation may be performed by holding one of the cooperating blades of each blade pair in a retracted position and repeatedly extending and retracting the other blade of the blade pairs. For example, the right-hand blades 62 and 64 (FIG. 3b) may be held in the retracted position while blades 58 and 60 are repeatedly retracted and extended, causing a shearing action whereby the blades 58 and 60 move to a position to shear and cut through the flashing formed at the jointure of the two joined frame members.

The shearing sequence may be alternated whereby the left-hand blades of assemblies 58, 60 perform shearing while the right-hand blades of assemblies 62 and 64 are retracted and the blade assemblies then reverse their operations so that the left-hand blades of assemblies 58 and 60 are retracted while the right-hand blades 62 and 64 perform the shearing operation.

The program of FIG. 11b provides for repeated shearing operations where one blade assembly is retracted while the cooperating blade assembly is extended. See steps 3-5; 21-23 and 27-29, for example, in addition to both extending and retracting at the same time. A variety of different combinations of cutting and shearing operations may be performed depending typically upon the nature of the material being trimmed.

In the example given, the frame members have a fairly regular and simple shape. It should be understood that the fixture and blade assemblies of the present invention may be provided with any desired configuration so as to conform to the profile of the frame members being joined and trimmed. For example, the frame profiles may be quite simple such as a gasket having substantially flat surfaces or maybe a frame for a window such as a storm window and have a much more complicated frame profile, as shown by the different profiles of FIGS. 12a to 12d.

In addition to the trimming apparatus embodiment described hereinabove, the present invention may be adapted for use in trimming joining members, such as, but not limited to, frame members and utilized with heating/fusing/joining apparatus capable of performing heating/fusing/joining operations on a single stack or frame or on multiple stacks of frames, simultaneously.

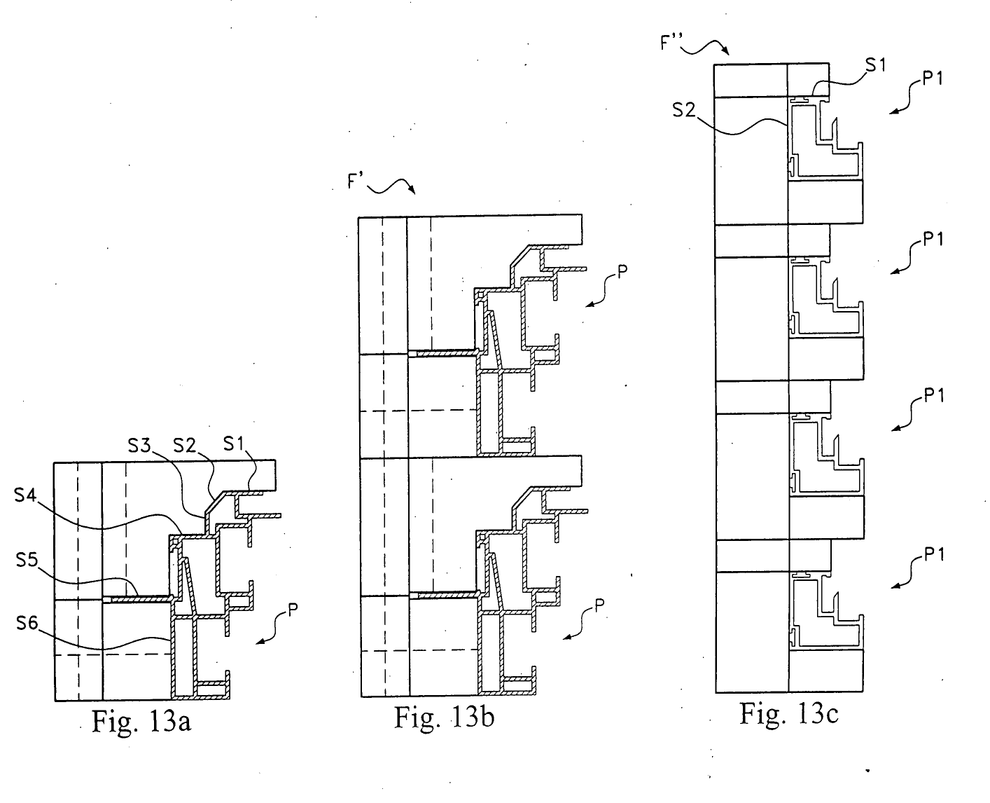

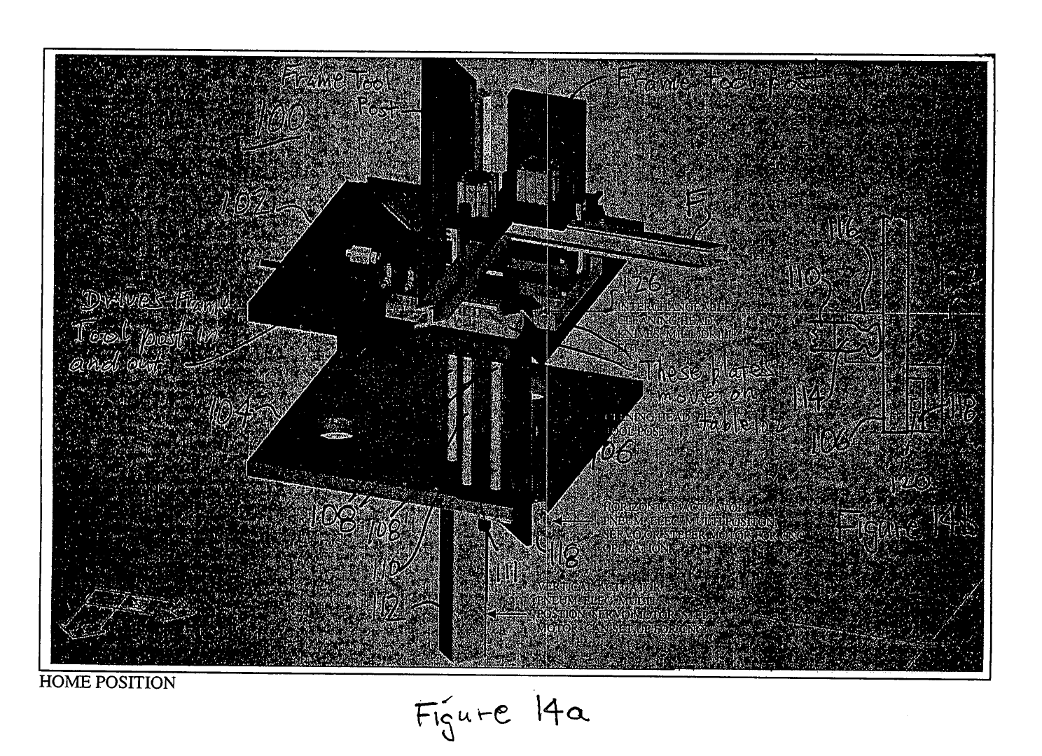

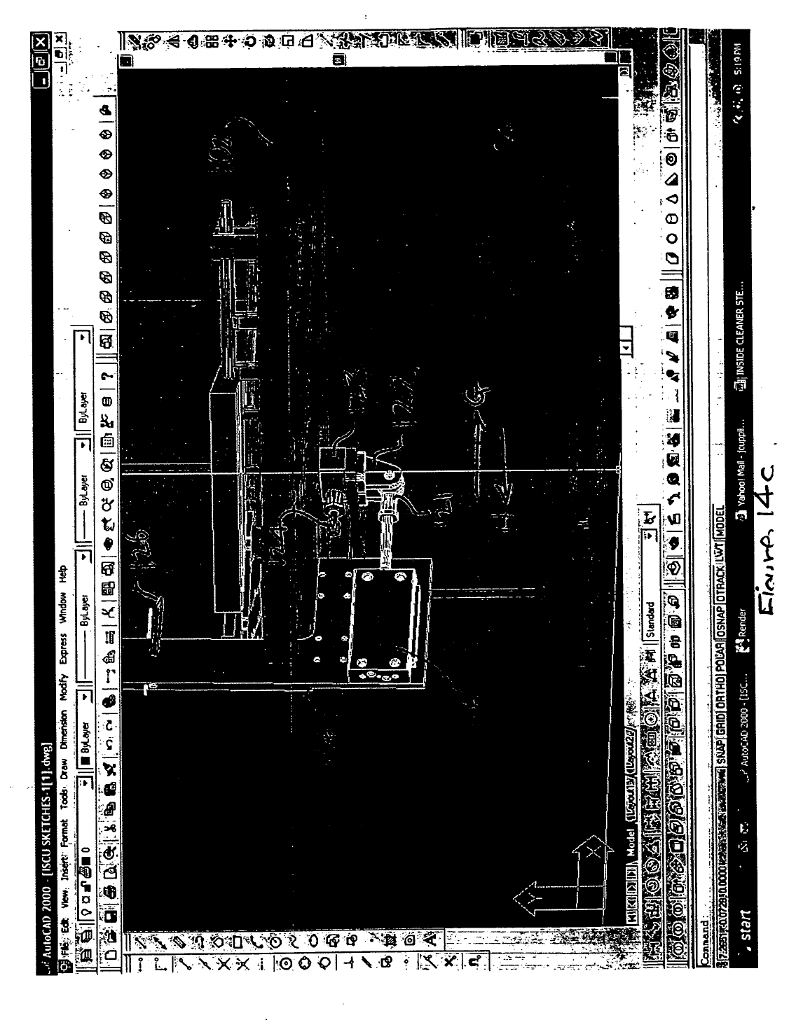

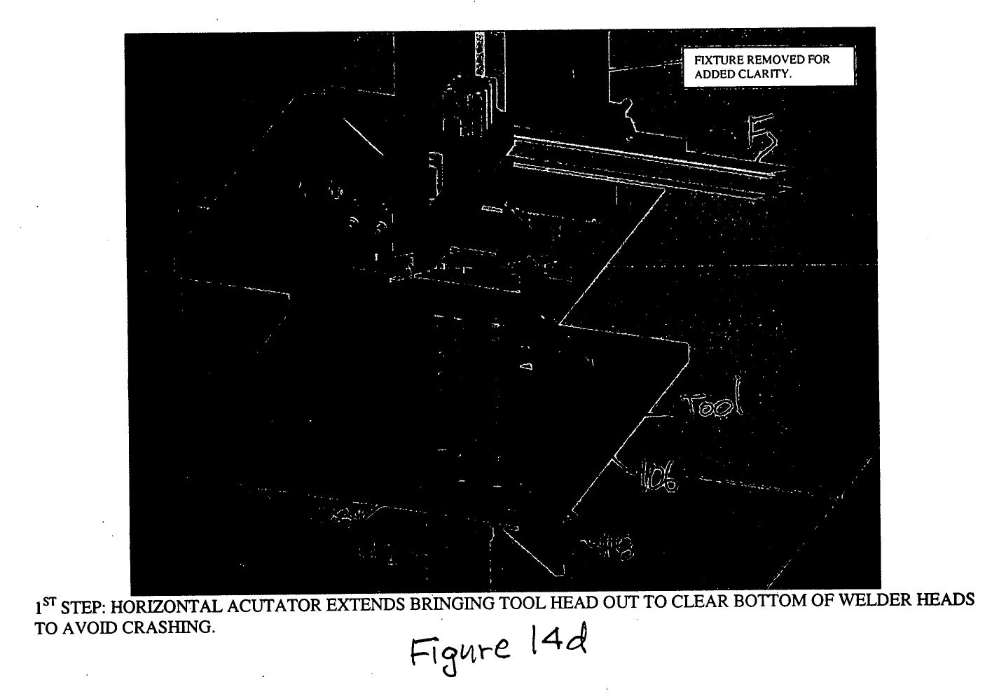

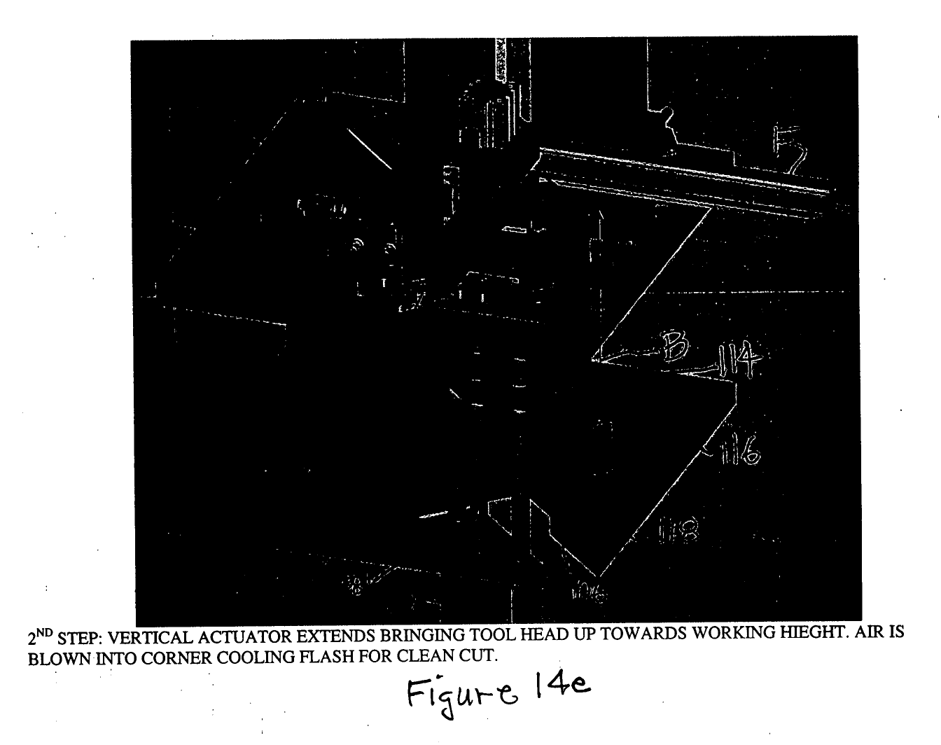

For example, the embodiment shown in FIG. 13a, as well as the embodiment of FIGS. 3 and 3a are utilized for trimming a single stack of profiles.

FIG. 13a shows a somewhat complex “right-hand” profile P arranged in a suitable clamping fixture F to be joined to a “left-hand” profile, not shown for purposes of simplicity. For example, the fixture 32, 34 of FIG. 2 is assumed to hold the “left-hand” profile and the fixture 36, 38 is assumed to hold the “right-hand” profile when viewing FIG. 2 from the left-hand side of FIG. 2. The surfaces to be trimmed are S1-S7.

Heating/fusing/joining structures are also available which are capable of simultaneously operating on a stack of two (2) or more members. For example, FIG. 13b shows two identical “right-hand” profiles P arranged in a suitable clamping fixture F′ in which the profiles P, similar to that shown in FIG. 13a, to be joined to “left-hand” profiles are arranged stacked one upon the other. Thus, for example, a single point or multiple point welder capable of joining frame members of two frames stacked one upon the other, may be utilized with the present invention to thereby simultaneously trim two stacked frame members which have been joined.

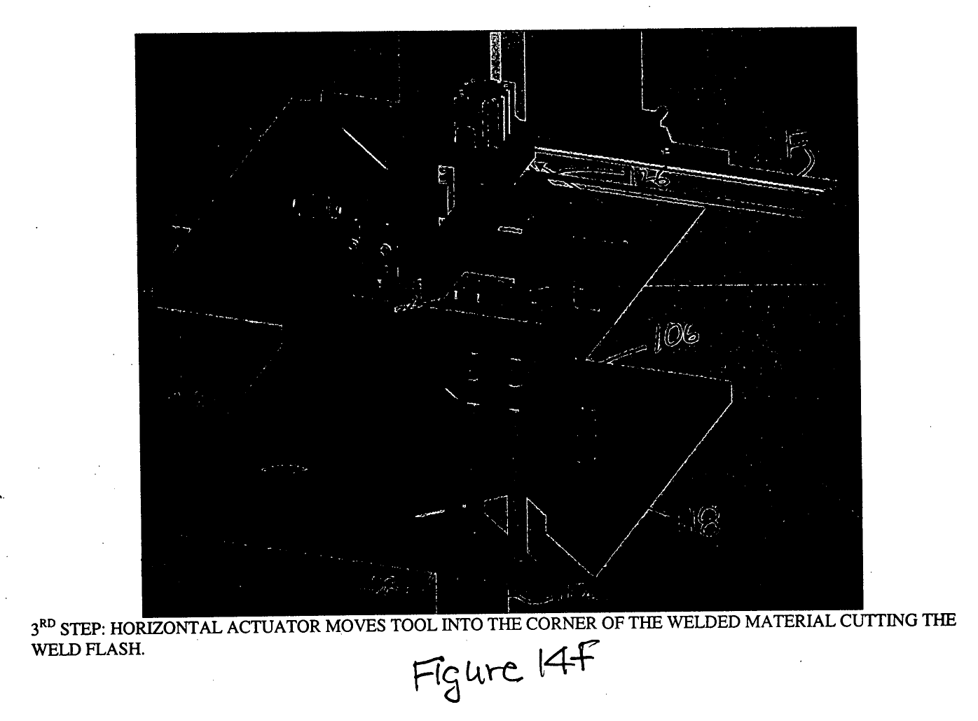

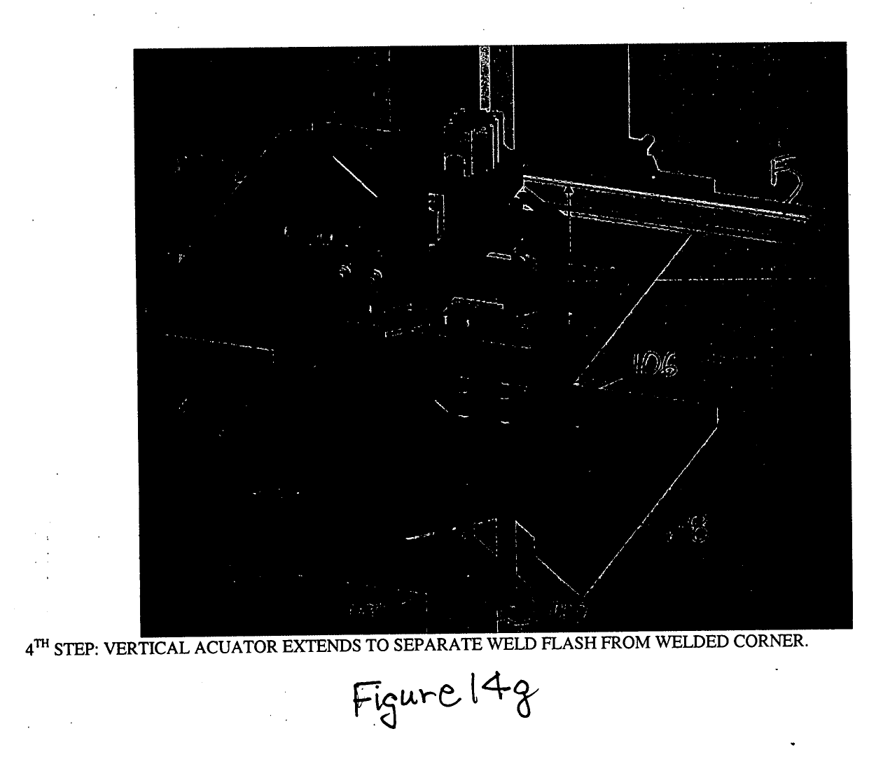

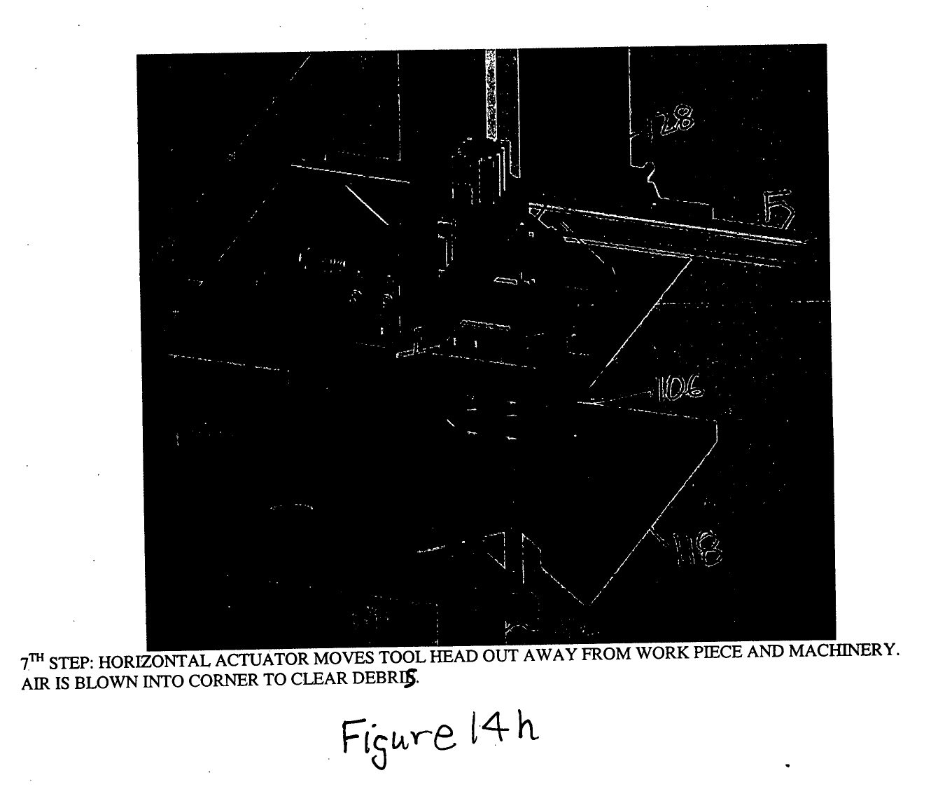

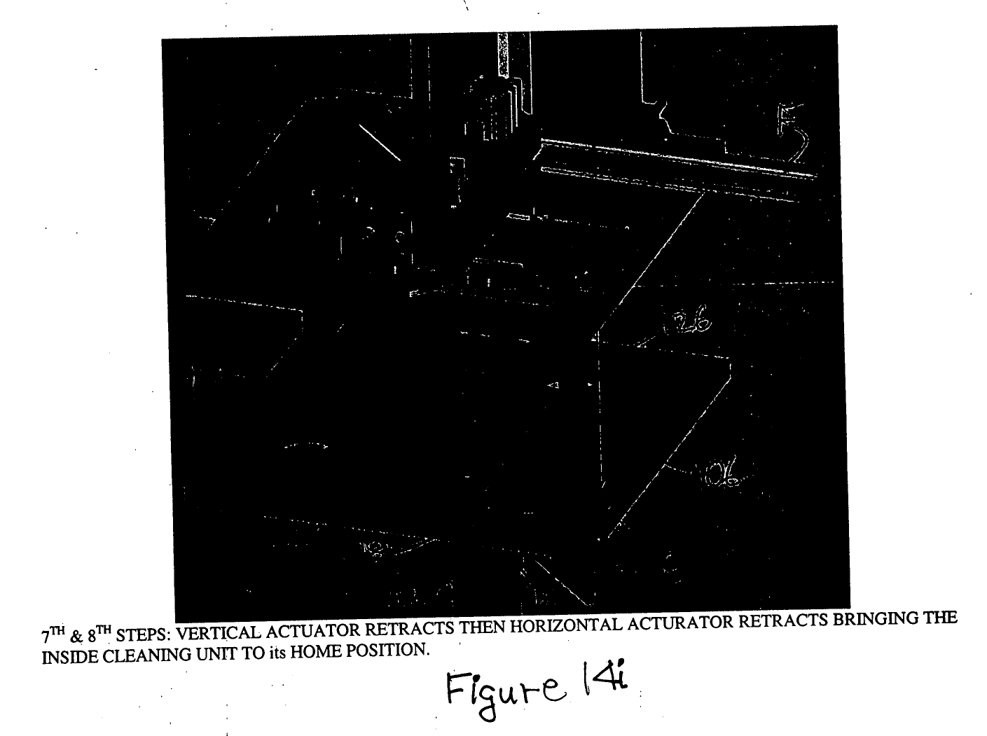

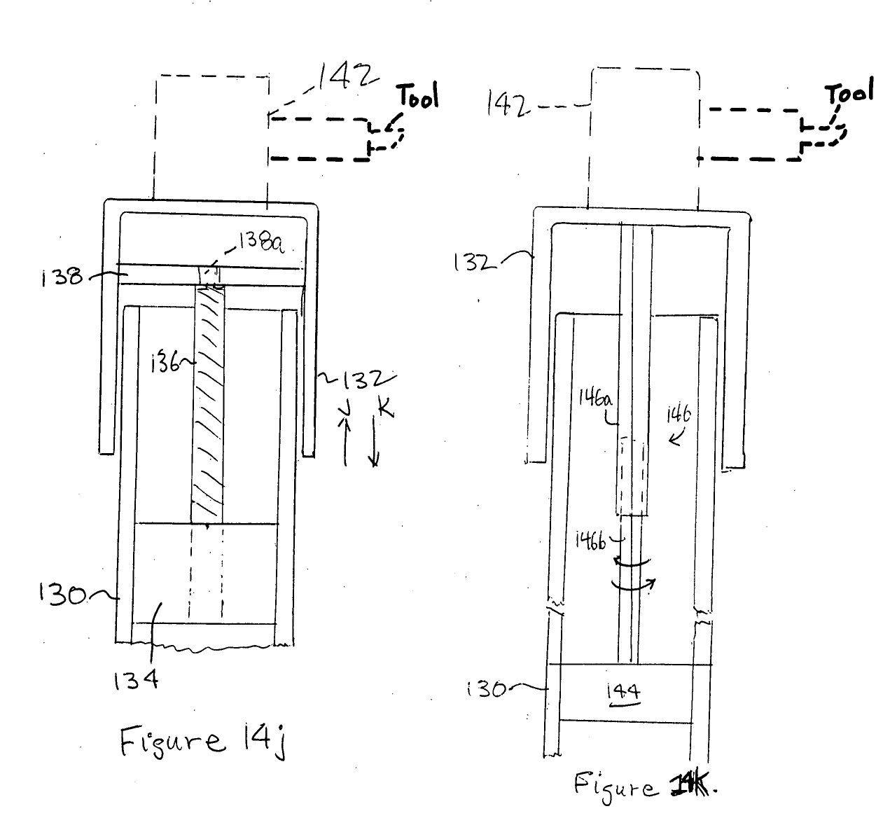

FIGS. 14a-14g are views of the interior cleaning system 100 which is compatible for use with and synchronized with the heating, fusing, and external trimming apparatus set forth above. The trimming assembly for trimming of the external surfaces shown in FIGS. 1-13c, are omitted from FIGS. 14a-14g to facilitate the explanation of the interior trimming/cleaning assembly.

Making reference initially to FIG. 14a, the internal cleaning/trimming apparatus 100 is supported by a pair of spaced, parallel upper and lower support plates 102 and 104. A plurality of cylindrical shaped rods 108 have their lower ends secured to plate 104 and their upper ends secured to plate 102. A main support plate 110, arranged below plate 102, is mounted for slideable movement in the upward/downward vertical direction, being guided by guide rods 108, main support plate 110 being provided with openings for slideably receiving cylindrical guide rods 108. The rods are joined to the plates 102 and 104 at their upper and lower ends. A vertical actuator 112, which may be any one of a pneumatic, electric multi-position servo motor or stepper motor, is mounted to the underside of support plate 104 for selectively driving main support plate 110 in either the upward or downward vertical direction. As one suitable example, one of the guide rods 108, such as, for example, guide rod 108′ may comprise a ball gear rotatably driven by actuator 112 and rotatable in a bearing (provided in plate 102) at its upper end to permit rotation of ball gear 108′ relative to upper plate 102. The opening provided in main support plate 110 and receiving ball gear 108′ is threaded to conform with the pitch of the ball gear 108′ and, by rotation of rod 108′ in a first direction, the main support plate 110 may be driven in the upward vertical direction and, by reverse rotation of the ball gear, the support plate may be driven in the downward vertical direction. When using a stepper motor, the ball gear drives the main support plate to a precise vertical location. In the event a motor other than a stepper motor is employed, a buffer 111 is mounted on main support plate 110 to cushion the plate 110 from impacting plate 102. Although the support plate 104 is shown positioned below plate 102, it should be understood that plate 104 may be positioned above plate 102 and main plate 110 may be positioned a spaced distance above plate 102 and below plate 104, now positioned above plate 102. The main plate may now be moved downwardly toward frame 5 in a manner similar to the upward movement of main plate 110 upward toward frame F.

FIG. 14a shows the main support plate 110 in the home position.

FIG. 14b shows an enlarged detailed view of a portion of the apparatus 100 and FIG. 14j is a perspective view showing the horizontal actuator components. An elongated member 114 extending substantially the length of the right-hand side of main support member 110 is secured to main support plate 110 and is slideably received within a guide member 116 having a shape which conforms to the external shape of member 114. Guide member 116 is secured to the replacable cleaning head tool post 106. A horizontal actuator 118 is secured to the surface of tool post 106 opposite the surface to which member 116 is secured and serves to selectively drive the replaceable cleaning head tool post 106 in the horizontal direction either toward or away from the frame assembly F to be trimmed and/or cleaned. The horizontal actuator may be a pneumatic or electric multi position servo or stepper motor for selectively moving the tool post 106 in the horizontal direction relative to main support plate 110. As one preferred embodiment, horizontal actuator 118 may drive an elongated ball gear 120 whose opposite end is rotatably supported within a suitable bearing 121 mounted upon a bracket 122 which is mounted to a support 123 secured to main plate 110. Rotation of the ball gear 120 in a first direction by actuator 118 extends the ball gear and drives the tool post 106 in the horizontal direction shown by arrow G relative to main support plate 110 toward the interior of frame F and rotation of the ball gear 120 in the reverse direction retracts the ball gear causing the tool post 106 to move in the reverse direction shown by arrow H to move the tool post relative to main support 110 and away from the frame F to be trimmed and/or cleaned. Lower plate 104 has a cut out portion 104a to provide clearance for movement of tool post 106 in the horizontal direction. Upper plate 107 has a similar cut out portion 102a for substantially the same purpose. A buffer 124 mounted on support 123 serves as a means to cushion the impact of the tool post 106 as it reaches the end of its movement toward the frame F. The frame F is held in place by clamps C similar to clamps 32, 34 described above and shown in FIGS. 3a and 3b.

FIG. 14a shows the tool post 106 in the home position with its interchangeable cleaning head 126 positioned so as to be displaced from the external trimming and the heating and fusing components, shown in detail in FIGS. 1-13c.

The head of the tool post receives interchangeable tools and may be rotated by a driving device. The head is capable of receiving knives, milling means, drills and other like tools for operating on the interior region of the frame F. The tool may also be an ultrasonic tool or a vibratory tool.

The tool post 106 may be extended in height as shown in FIG. 14j. The post comprises lower and upper telescoping housings 130, 132. An activator 134 in one embodiment is placed in the lower housing 130 and drives ball gear 136. The upper end of ball gear 136 is rotatably mounted in bearing 138a in plate 138 mounted to upper housing 132. The ball gear threadedly engages a threaded member (not shown) in activator 134. Rotation of motor in 134 in a first direction drives ball gear 136 and housing 132 vertically upward as shown by arrow J and rotation in the opposite direction moves ball gear 136 and housing 132 vertically downward as shown by arrow K. The tool head 142 is mounted upon upper housing and is configured to receive a variety of tools 132.

To operate a drill or other tool head which requires that it be rotated, a drive shaft 146 is coupled between a drive motor 144 in lower housing 130 and a rotatable tool head 142, as shown in FIG. 14k. Drive shaft 146 is comprised of two telescoping shafts 146a, 146b which may have a square-shaped cross-section. The telescoping shafts 146a, 146b move relative to one another depending upon the drive imparted to ball gear 136 by actuator 134. Motor 144 selectively rotates the shaft 146 in either a clockwise or counter clockwise direction. The actuator assembly of FIG. 14j and the drive assembly of FIG. 14k are displaced from one another in the housings 130, 132 so as not interfere with their respective operations. In order to perform an interior cleaning operation or the like, the horizontal actuator 118 is operated to move the tool head horizontally in the direction shown by arrow A to move the tool post 106 from the position shown in FIG. 14a to the position shown in FIG. 14d.

When the tool post 106 has been brought to a position where the tool head is clear of the welder heads, actuator 112 is operated to move the main support plate 110 in the upward vertical direction to bring the tool head 126 toward the working height position shown in FIG. 14e, arrow B showing the direction of vertical movement from the position shown in FIG. 14d that shown in FIG. 14e.

Once the tool head reaches the position in FIG. 14e, horizontal actuator 118 is operated to move the tool head 126 into the region of the interior corner of the joined frame members in readiness for removing internal flashing as shown in FIG. 14f, see arrow C. The horizontal and vertical actuators 112 and 118 may then be selectively operated to trim the flashing. For example, the vertical actuator may be brought to the position shown in FIG. 14g so that a trimming blade mounted on the tool head engages horizontal surface F₁ in the inside corner of the two joined frame pieces. The horizontal actuator 118 is then operated to move a trimming blade mounted on the tool head upward and downward to scrape or trim that surface. The blade is shaped to conform to the contour of the surface being cleaned/trimmed, in a manner similar to the blades shown in FIGS. 7a to 10c. The actuator 118 may then be operated to move the trimming tool into engagement with vertical surfaces F₂. The vertical actuator 112 is then operated to cause the trimming tool to move up and down to trim the outside corner vertical surfaces F₂. The vertical actuator 112 may then be operated to bring the trimming tool against the interior horizontal surfaces F₃ and the horizontal actuator 118 is then operated to move the cleaning tool backward and forward to clean these surfaces. The tool head post may be moved by operating both horizontal 118 and vertical 112 activators substantially simultaneously to define a curved path of motion if desired.

Although in the example given, backward and forward movement of the cleaning tool is described to clean the surfaces F₁, F₂, F₃, the tool may be moved in only one (1) direction or may be moved backward and forward more than once to achieve the desired cleaning operation. The tool head may be fitted with a buffing or grinding tool as an alternative to a trimming blade, or an ultrasonic or vibratory tool for cleaning or other operations. The tool head also may be fitted with a screw driver tip for a inserting a screw or drill for drilling a hole in the frame members.

The tool post is further provided with an air injecting nozzle 128 for blowing air into the corner to effect cooling of the flashing preparatory to cutting. The air nozzle may also be operated subsequent to the cutting operation to blow the debris removed by the cleaning tool away from the frame members F which have just been cleaned, as shown in FIG. 14h.

After the cleaning operation is complete the vertical actuator 112 drives the tool post 106 horizontally and away from frame F and drives the main support plate 110 vertically downward as shown by arrows D and E in FIGS. 14h and 14i to its home position and thereafter the horizontal actuator 18 drives the tool post 106 in the horizontal direction by arrow D to bring the tool post to the home position, in readiness for a subsequent cleaning operation.

In applications where it is desired to provide for interior cleaning of first and second stacked frame members, the tool post is provided with a second cleaning tool 126′ and a second air nozzle 128′. The second pair of frame members and the clamping and guiding devices therefore have been omitted from FIGS. 14a and 14d through 14i for purposes of simplicity, it being understood that a support plate similar to support plate 102 is positioned between support plate 102 and 104 and is appropriately located therebetween so as to cooperate with the lower cleaning tool 126′ and air blowing nozzle 128′.

As is mentioned above, the cleaning head maybe interchanged with other types of heads such as a drilling head, trimming knife or the like. The drill may be utilized to drill holes in the frame. The air nozzles, although not shown for simplicity, have their right-hand ends extending rearwardly from the tool posts for coupling to flexible tubing (not shown) for delivering air under pressure from a suitable pressurized air source (not shown) to the air nozzles 128 and 128′. The pressurized air source may be either the shop pressure or high pressure obtained from source 14 shown in FIG. 1.

Single or multiple point welders are not limited to joining and trimming double stacks and may be utilized to join multiple stacks greater in number than two. For example, FIG. 13c shows a “quad” stack in which four (4) “right-hand” profiles P1 are arranged stacked one upon another in a frame assembly F″ for joining with Four (4) cooperating “left-hand” profiles. The trimmer arrangement of the present invention may trim surfaces S1-S3 of the “quad” stack of profiles P1, the actual number of stacked profiles to be trimmed being a function of the single or multiple point welding apparatus as to whether it is capable of handling a single stack or multiple stacks of profiles.

It should be understood that the profiles for single, double or quad stacks are held by clamping fixtures similar to those respectively shown in FIGS. 13a-13c.

It can be seen that the present invention provides a novel apparatus and method for trimming and/or cleaning plastic frame members and the like, and which is utilized in conjunction with conventional welding apparatus enabling the trimming operation to be performed while the frame members are retained at the welding apparatus thus eliminating the need for removing the fused frame members and relocating them to a separate independent apparatus. Although the preferred embodiment is directed to joining frame members, it should be understood that the trimming apparatus of the present invention may be used to trim any joined plastic members, regardless of their orientation and may be used to trim members whose center lines are arranged to be parallel, perpendicular or any angle therebetween.

What is claimed is:

1. A method for trimming flashing from joined plastic members, said flashing extending outwardly from exterior surfaces of the joined plastic members in a region where the plastic members are joined, comprising:
(a) clamping the joined plastic members between first and second clamps;
(b) imparting movement to at least one trimming assembly guided by a guide on at least one of said clamps to move the trimming assembly in a direction to trim a first portion of said flashing;
(c) moving a tool post from a position displaced from the joined plastic members to a position adjacent said joined plastic members; and
(d) operating a tool on said tool post to trim a second portion of said flashing.

2. The method of claim 1 further comprising:
(e) performing step (a) a plurality of times.

3. The method of claim 1 wherein step (a) further comprises:
(e) moving said trimming assembly so as to shear the flashing.

4. The method of claim 1 wherein step (a) further comprises:
(e) providing a pair of trimming assemblies;
(f) retracting one of said pair of trimming assemblies away from said flashing; and
(g) extending another one of said pair of trimming assemblies to move the extended trimming assembly across the region of the flashing for shearing the flashing.

5. The method of claim 4 further comprising:
(h) reversing the extending and retracting operations in steps (f) and (g) of said pair of trimming assemblies so that said one of said pair of blades performs a shearing operation on said flashing while said another one of said pair of trimming assemblies is retracted.

6. The method of claim 5 wherein the shearing operations of the pair of trimming assemblies is reversed a plurality of times.

7. Apparatus for trimming flashing from first and second joined plastic members, comprising:
a pair of cooperating fixtures for clamping the first and second plastic members;
a heating plate for heating and softening ends of the first and second members to be joined;
fixture actuators for moving the first and second members in a direction to bring heated, softened surfaces of said first and second members into engagement, causing fusion of the members at the heated softened surfaces, whereby a portion of the heated material is forced out from between the engaging surfaces to form flashing;
at least one of said fixtures having a guide;
at least one first trimming assembly movable along said guide;
a trimming actuator for moving said first trimming assembly along said guide to move the trimming assembly in a first direction transverse to the heated surfaces to thereby move the trimming assembly from a position displaced from the flashing and a second direction opposite said first direction to trim flashing in a first given region;
a second trimming assembly for removing flashing in a second region; and
means for selectively moving the second trimming assembly in mutually orthogonal directions between a position displaced from said frames and a second position adjacent said first and second members to trim flashing in a second region.

8. The apparatus of claim 7 further comprising a locking mechanism for locking said clamps to one another before said trimming actuator is operated.

9. The apparatus of claim 8 wherein said locking apparatus comprises a member on one of said fixtures movable between a locking engagement position with a pin on the other one of said fixtures and a displacement position from said pin.

10. The apparatus of claim 8 wherein said locking apparatus comprises a locking pin on one of said fixtures and a locking plate movably mounted on another one of said fixtures; and
a locking actuator for moving said locking plate in a first direction to capture said locking pin in a locking slot in said locking plate and in a second direction to displace the locking slot from the locking pin.

11. The apparatus of claim 7 further comprising clamping actuators for clamping a frame member between said fixtures when in a first state and for releasing clamping pressure from said fixtures when in a second state.

12. The apparatus of claim 7 further comprising a programmed logic controller for selectively controlling the locking mechanism and trimming actuators according to pre-programmed sequence.

13. The apparatus of claim 11 wherein said clamping actuators are pneumatic actuators;
first and second pneumatic pressure sources for respectively providing low and high output pressure at their outputs; and
control valves for respectively coupling said clamping actuators to said first pneumatic pressure source when in a first state and for coupling said clamping actuators to said second pneumatic pressure source when in a second state.

14. A method for trimming flashing from stacks of joined plastic members comprising the steps of:
(a) arranging multiple stacks of first and second plastic members;
(b) clamping first and second plastic members of each of said stacks between cooperating clamps;
(c) moving the sets of clamps in a direction to bring heated, softened surfaces of said members into engagement causing fusion of the members in the region of the heated softened surfaces, whereby a portion of the heated molten material is forced out from between the engaging surfaces, forming flashing;
(d) affixing at least one guide to each set of clamps;
(e) providing at least one trimming assembly for each set of clamps;
(f) imparting movement to each trimming assembly each being guided by an associated one of said guides to move the trimming assemblies in a direction transverse to the heated surfaces to thereby move the trimming assemblies from a first position, displaced from the flashing toward a second position to simultaneously trim a first portion of the flashing of each of the joined members clamped by said sets of clamps; and
(g) selectively moving a second trimming assembly in mutually perpendicular directions from a position displaced from said frames to a position adjacent to said frames for simultaneously trimming a second portion of flashing from each of said stacks of frames.

15. Apparatus for trimming flashing from stacks of joined plastic members comprising:
means for clamping multiple stacks of first and second plastic members between cooperating clamps;
means for moving the sets of clamps in a direction to bring heated, softened surfaces of said members into engagement causing fusion of the members in the region of the heated softened surfaces, whereby a portion of heated softened material is forced out from between the engaging surfaces, forming flashing;
each set of clamps being provided with at least one guide;
at least one trimming assembly provided for each set of clamps, each trimming assembly being guided by an associated one of said guides;
means for moving the trimming assemblies in a direction transverse to the heated surfaces to thereby move the blade assemblies from a first position, displaced from said flashing, toward second position to simultaneously trim first a portion of the flashing of each of the joined members clamped by said sets of clamps;
a second trimming assembly having a plurality of trimming tools for each frame of said stack of frames; and
means for simultaneously moving said trimming tools including means for selectively moving the second trimming assembly in mutually perpendicular directions from a first position displaced from said frames to a second position adjacent to said frames for simultaneously trimming a second portion of the flashing of each of the frames by an associated tool.

16. A method for operating on a region of plastic members having heated end surfaces to be joined, comprising:
(a) moving said members to bring the heated end surfaces into engagement thereby causing flashing along surfaces of said members adjacent to the end surfaces being joined;
(b) holding a tool post displaced from said members during performance of step (a);
(c) moving the tool post in a first direction and a second direction transverse to said tool direction to bring said tool post adjacent to said members; and
(d) manipulating a tool on said tool post to remove flashing.

17. The method of claim 16, further comprising:
(e) cooling said flashing preparatory to step (d).

18. The method of claim 16, further comprising:
(e) applying pressurized air to said joined members subsequent to step (d) to clear the interior surface of debris due to manipulation of said tool.

19. The method of claim 16 wherein step (d) further comprises;
(e) moving the tool back and forth along surfaces of said members to remove flashing.

20. The method of claim 16, further comprising;
(e) providing a cutting tool on said tool post; and
(f) moving the cutting tool along the joined members to trim said flashing.

21. The method of claim 16 further comprising;
(e) providing a tool holder on said tool post for removably receiving a tool; and
(f) mounting a tool on the tool holder.

22. The method of claim 21 further comprising:
(f) forming said tool post of a first post member and second post member movable relative to said first post member and supporting the tool on said second post member to provide an additional range of motion.

23. The method of claim 22 further comprising:
(g) moving said second post member in a direction parallel to one of said first and second directions.

24. The method of claim 16 comprising:
(e) providing said tool head with a rotatable member; and step (d) further comprises rotating said rotatable member for cleaning said joined members.

25. The method of claim 16 further comprising:
(e) providing said tool head with a rotatable member; and step (d) further comprises rotating said rotatable member for drilling a hole in one of said joined members.

26. The method of claim 16 further comprising:
(e) providing a movable platform;
(f) slidably mounting said tool post to said movable platform;
(g) moving said platform in said first direction to thereby move the tool post in said first direction; and
(h) moving said tool relative to said platform in said second direction.

27. Apparatus for operating on a region of plastic members having heated end surfaces to be joined, comprising:
means for moving said members to bring the heated end surfaces into engagement thereby causing flashing along surfaces of said members adjacent to the end surfaces being joined;
a tool post having a tool mounted thereon; and first and second actuators selectively operable for moving said tool post between a first position displaced from said members and a second position adjacent to said members, said first and second actuators respectively moving the tool post in first and second mutually perpendicular directions; and
one of said first and second actuators being operated responsive to said tool post reaching said second position to cause the tool on said tool post to remove flashing.

28. The apparatus of claim 27, further comprising:
means for cooling said flashing.

29. The apparatus of claim 27, further comprising:
means for applying pressurized air to said joined members to clear debris from the joined members.

30. The apparatus of claim 27, further comprising;
said one of said first and second actuators being operated to move the tool back and forth along surfaces of at least one of said joined members to remove flashing.

31. The apparatus of claim 27, further comprising;
said tool being a cutting tool on said tool post to trim said flashing when said one of said first and second actuators is operated.

32. The apparatus of claim 27 further comprising;
a tool holder on said tool post for removably receiving a tool; and, said tool being removably mounted in the tool holder.

33. The apparatus of claim 21 further comprising:
said tool post being comprised of a first post member and second post member movable relative to said first post member, said second post member supporting the tool; and
a third actuator for moving said second post member.

34. The apparatus of claim 33 wherein said third actuator is configured to move said second post member in a direction parallel to one of said first and second directions.

35. The apparatus of claim 27, comprising:
said tool head having a rotatable member for receiving a tool.

36. The apparatus of claim 35, further comprising means for rotating said rotatable member.

37. The apparatus of claim 35 wherein said tool is a one of a drill, a screw driver a grinding member, a polishing member and a trimming blade.

38. The apparatus of claim 27, further comprising:
a movable platform;
said tool post being slidably mounted to said movable platform;
said first actuator moving said platform in said first direction to thereby move the tool post in said first direction; and
said second actuator moving said tool post relative to said platform in said second direction.

39. Apparatus for operating on a region of plastic members having heated end surfaces to be joined, comprising:
means for moving said members to bring the heated end surfaces into engagement thereby causing flashing along surfaces of said members adjacent to the end surfaces being joined;
a tool post having a tool mounted thereon; and
first and second actuators selectively operable for moving said tool post between a first position displaced from said members and a second position adjacent to said members, said first and second actuators respectively moving the tool post in first and second mutually perpendicular directions; and
said tool being configured perform an operation on said joined members.

40. The apparatus of claim 39 wherein said tool is a one of a drill, a screw driver a grinding member, a polishing member and a trimming blade.

41. The apparatus of claim 7 wherein the means for moving the second trimming assembly moves the second trimming assembly along a curved path.

42. The apparatus of claim 7 wherein the means for moving the second trimming assembly moves the second trimming assembly along first and second linear paths perpendicular to one another.
